(19) United States
(12) Patent Application Publication
(10) Pub. No.: US 2024/0019882 A1
(43) Pub. Date: Jan. 18, 2024

(54) Intelligent Temperature Control of Equipment Using Sensors

(71) Applicant: Hello Therma Inc., San Francisco, CA (US)

(72) Inventors: Manik Varun Suri, San Francisco, CA (US); Andrew Hager, Solvang, CA (US); Christophe Niglio, Dillon, MT (US); Dolf Bouwe Joseph August Andringa, Valencia (PH)

(21) Appl. No.: 18/222,330

(22) Filed: Jul. 14, 2023

Related U.S. Application Data
(60) Provisional application No. 63/389,818, filed on Jul. 15, 2022.

(51) Int. Cl. G05D 23/24; G05B 13/02

(52) U.S. Cl. CPC G05D 23/24; G05B 13/0265

(57) ABSTRACT

A system performs intelligent temperature control of equipment, for example, refrigeration equipment, heating equipment, air-conditioning equipment. The system receives signal generated by a sensor mounted in the equipment, for example, a thermistor. The signal monitors an attribute of the equipment, for example, temperature, pressure, or humidity. The system determines an optimal target attribute value for the equipment. The system modifies the signal received from the sensor to generate a modified signal for achieving the optimal target attribute value for the equipment. The system may use a device with variable resistors for generating the modified signal. The system sends the modified signal to a control module of the equipment. The control module controls the equipment to achieve the optimal target attribute value.

### CROSS-REFERENCE TO RELATED APPLICATION

This application claims the benefit of U.S. Provisional Application No. 63/389,818, filed on Jul. 15, 2022, which is incorporated by reference in its entirety.

### FIELD OF INVENTION

The disclosure relates to control of refrigeration equipment in general and more specifically to adjusting signal based on a thermistor received from refrigeration equipment to control the refrigeration equipment.

### BACKGROUND

Refrigeration equipment typically uses thermistor for controlling the temperature of the equipment. A thermistor is a temperature-dependent resistor that changes resistance with changes in temperature. A thermistor senses temperature changes in the refrigeration equipment and sends a signal to a control system of the refrigeration equipment which takes action in response to the temperature change. For example, if the temperature of the refrigeration equipment rises, the thermistor sends a signal indicating the rise in the temperature and the control system may turn on cooling cycles to reduce the temperature. Similarly, the thermistor also detects excessive cooling of the equipment so that the control system may increase the temperature of the equipment.

### SUMMARY

The system disclosed performs intelligent temperature control of equipment, for example, refrigeration equipment, heating equipment, air-conditioning equipment. The system receives signal generated by a sensor mounted in the equipment. The signal monitors an attribute of the equipment, for example, temperature, pressure, or humidity. The system determines an optimal target attribute value for the equipment. The optimal target attribute value based on a plurality of factors including the signal and one or more external factors. The system modifies the signal received from the sensor to generate a modified signal for achieving the optimal target attribute value for the equipment. The system sends the modified signal to a control module of the equipment. The control module controls the equipment to achieve the optimal target attribute value.

According to an embodiment, the techniques can be used to control temperature of refrigeration equipment. The system receives signal generated by a thermistor mounted in the refrigeration equipment. The system determines an optimal temperature for the refrigeration equipment. The optimal temperature determined based on a plurality of factors including the signal and at least one or more external factors. The system modifies the signal received from the thermistor to generate a modified signal for achieving the optimal temperature. The system sends the modified signal to a control module of the refrigeration equipment. The control module controls the refrigeration equipment to change a current temperature of the refrigeration equipment towards the optimal temperature.

An embodiment comprises a device for controlling temperature of a refrigeration equipment. The device comprises an input port for receiving a voltage signal from a thermistor of the refrigeration equipment. The device comprises a communication module for receiving data from an external system. The device comprises a processor for determining a modified signal based on the voltage signal received from the thermistor and the data received from the external system. The device comprises one or more variable resistors connected to the thermistor, wherein changing the one or more variable resistors causes a voltage across the thermistor to generate the modified signal. The device comprises an output port for sending the modified signal to a control module of the refrigeration equipment.

The techniques disclosed may be implemented as computer-implemented methods, as non-transitory computer readable storage media comprising instructions that when executed by one or more computer processors, cause the one or more computer processors to perform steps of methods disclosed herein, or as computer systems comprising, one or more computer processors and a non-transitory computer readable storage medium comprising instructions that when executed by one or more computer processors, cause the one or more computer processors to perform steps of the methods disclosed herein.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1A shows the overall system environment for the intelligent temperature control of refrigeration equipment, according to an embodiment.

FIG. 1B shows the overall system environment for the intelligent control of an attribute of any equipment, according to an embodiment.

FIG. 1C shows the overall system environment for multi-equipment orchestration, according to an embodiment.

FIG. 1D illustrates various techniques used for controlling the temperature of an equipment according to various embodiments.

FIG. 2 shows the system architecture of an intelligent temperature control system, according to an embodiment.

FIG. 3 illustrates a temperature control model used by the intelligent temperature control system, according to an embodiment.

FIG. 4 shows a hardware architecture of a system used for intelligent temperature control of equipment, according to an embodiment.

FIG. 5 is a flowchart illustrating the overall process of controlling temperature of refrigeration equipment according to an embodiment.

FIG. 6 is a flowchart illustrating the overall process of controlling an attribute of an equipment according to an embodiment.

FIG. 7 is a block diagram illustrating components of an example machine able to read instructions from a machine-readable medium and execute them in a processor.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### DETAILED DESCRIPTION

Conventional systems control the temperature of the refrigeration equipment based on signal received from the thermistor. The flow of electricity through a thermistor changes based on its temperature. Accordingly, the thermistor generates a signal based on the temperature of the equipment associated with the thermistor, for example, the equipment in which the thermistor is installed. However, there are several other factors that may be relevant to controlling temperature of a refrigeration equipment. For example, the other equipment that is running in a facility may be relevant to the temperature of the refrigeration equipment since that affects the overall energy consumption of the facility. Conventional techniques control the temperature based on signal provided by the thermistor which is based on the temperature changes of the refrigeration equipment.

According to an embodiment, a system performs intelligent control of temperature of refrigeration equipment using a thermistor. The system intercepts the signal generated by the thermistor and adjusts it based on various factors. Accordingly, the system provides a modified signal that is different from the signal generated by the thermistor to the control system of the refrigeration equipment. This allows the system to perform intelligent control of temperature of the refrigeration equipment that considers various factors. For example, the system further monitors the power consumption of the equipment and adjusts the temperature to optimize the power consumption. This improves the energy efficiency of the equipment. Accordingly, the system may control the equipment in a manner that is different from the user provided configuration and is based on optimization of other factors such as power consumption. For example, a user may set the temperature of the refrigeration equipment to an extreme value that may result in high power consumption. The system instead sets the temperature that may be different from the user configured value that is sufficient for the purpose for which the refrigeration equipment is being used but consumes less power.

Although the techniques disclosed are described in connection with refrigeration equipment, the techniques can be applied to other types of equipment, for example, air conditioning equipment, heating equipment such as ovens and so on.

Although the techniques disclosed herein are described using a thermistor, the techniques are applicable to any kind of sensor, for example, pressure sensor, humidity sensor, temperature sensor, and so on. The sensor may return analog signal or digital signal. The techniques are applicable to any control system utilizing a feedback signal. The system as disclosed intercepts the feedback signal and controls the feedback signal by adjusting the signal. For example, if a system uses a digital interface to a sensor, the system modifies the digital signal to modify the feedback signal on the fly to implement the controls described herein.

### Overall System Environment

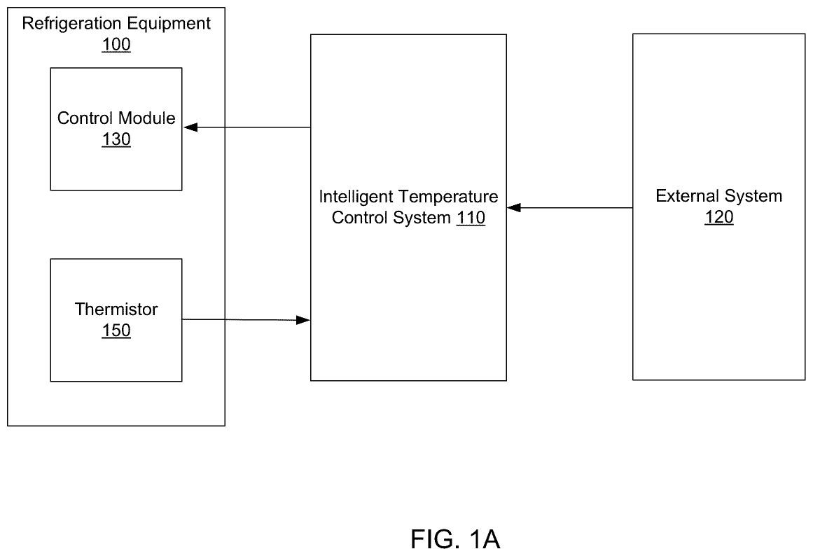

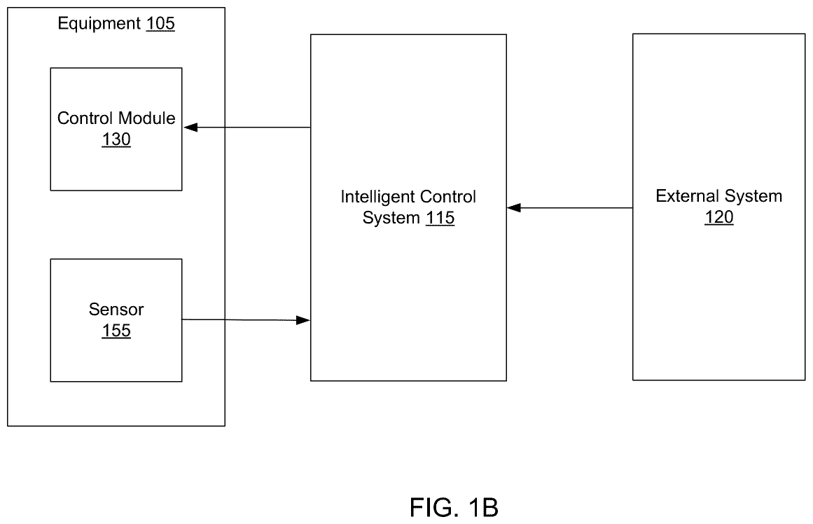

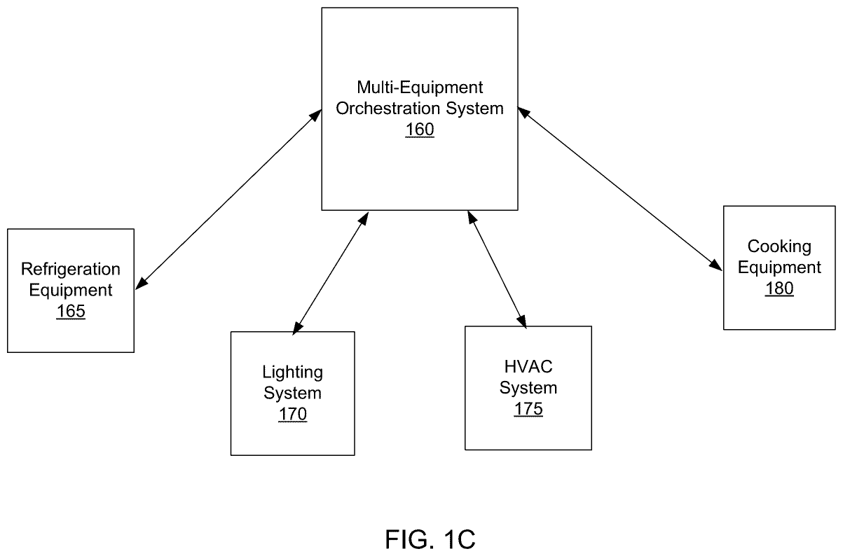

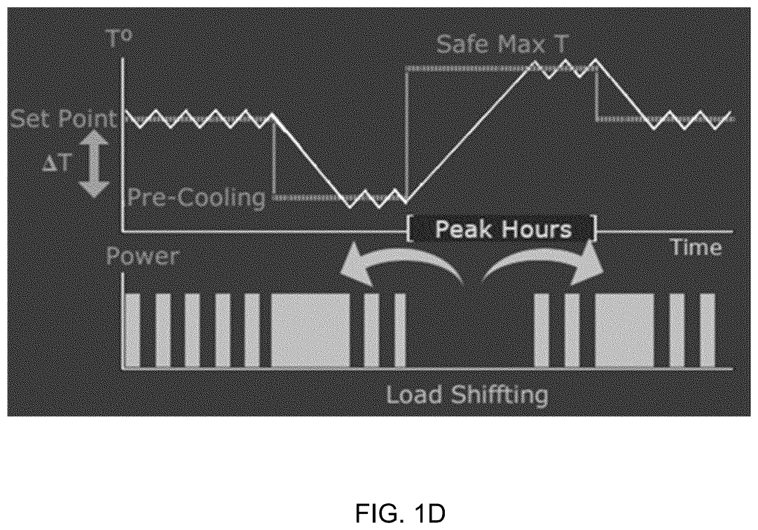

FIG. 1A shows the overall system environment for the intelligent temperature control of refrigeration equipment, according to an embodiment. The system environment includes refrigeration equipment 100, an intelligent temperature control system 110 and one or more external systems 120. In other embodiments, more or fewer components than those indicated in FIG. 1 may be used. For example, there may be more or fewer instances of equipment 100 shown in FIG. 1.

The intelligent temperature control system 110 controls the temperature of the refrigeration equipment 100. The embodiments disclosed herein are described in connection with refrigeration equipment, but the techniques are applicable to other types of equipment as shown in FIG. 1B. The refrigeration equipment 100 uses a thermistor to sense and control temperature of the refrigeration equipment 100. In certain configurations, the intelligent temperature control system 110 is installed on a device directly connected to the refrigeration equipment 100.

The intelligent temperature control system 110 receives signal indicating the temperature of the refrigeration equipment 100 that may be generated by a thermistor of the equipment 100, for example, voltage signal that depends on the temperature of the refrigeration equipment 100. The intelligent temperature control system 110 modifies the signal to generate a modified signal and send the modified signal to the refrigeration equipment 100 to control the temperature of the equipment based on factors other than the signal.

In some embodiments, the intelligent temperature control system 110 receives information from the external system 120 and uses that in addition to the signal received form the equipment to determine the modified signal value. In some embodiments, the intelligent temperature control system 110 is a powerful processing device that is capable of executing the instructions for determining the modified signal value, for example, any optimization techniques. In other embodiments, the intelligent temperature control system 110 acts as a communication device that sends the signal value to an external system 120. The external system 120 determines the modified signal value and send to the intelligent temperature control system 110 which provides the modified signal value to the equipment 100.

FIG. 1 and the other figures use like reference numerals to identify like elements. A letter after a reference numeral, such as “120a,” indicates that the text refers specifically to the element having that particular reference numeral. A reference numeral in the text without a following letter, such as “120,” refers to any or all of the elements in the figures bearing that reference numeral (e.g., “120” in the text refers to reference numerals “120a” and/or “120b” in the figures).

The techniques disclosed herein are not limited to refrigeration equipment and control of temperature and may be applied to other types of attributes of equipment, for example, pressure, humidity, and so on or equipment such as air conditioning equipment, heating equipment, and so on.

FIG. 1B shows the overall system environment for the intelligent control of an attribute of any equipment, according to an embodiment. The system environment includes equipment 105, an intelligent control system 115 and one or more external systems 120. In other embodiments, more or fewer components than those indicated in FIG. 1 may be used. For example, there may be more or fewer instances of equipment 105 shown in FIG. 1.

The equipment 105 may represent machines or appliances for which an attribute is controlled by the intelligent control system 115. The equipment 100 may be refrigeration equipment, air conditioning equipment, heating equipment, any machinery that needs temperature control, medical equipment, and so on. The attribute controlled may be pressure, humidity, and so on that is controlled using a sensor. In certain configurations, the intelligent control system 115 is installed on a device directly connected to the equipment 105.

The intelligent control system 115 receives signal indicating the attribute of the equipment 100 that may be generated by a sensor of the equipment 105, for example, voltage signal that depends on the attribute value of the equipment 105. The intelligent control system 115 modifies the signal to generate a modified signal and send the modified signal to the equipment 105 to control the attribute of the equipment 105 based on factors other than the signal.

In some embodiments, the intelligent control system 115 receives information from the external system 120 and uses that in addition to the signal received form the equipment to determine the modified signal value. In some embodiments, the intelligent control system 115 is a powerful processing device that is capable of executing the instructions for determining the modified signal value, for example, any optimization techniques. In other embodiments, the intelligent control system 115 acts as a communication device that sends the signal value to an external system 120. The external system 120 determines the modified signal value and send to the intelligent control system 115 which provides the modified signal value to the equipment 105.

The system shown in FIG. 1A and FIG. 1B can be used for orchestration of equipment such as refrigeration equipment in conjunction with multiple other equipment that may be present in a facility. FIG. 1C shows the overall system environment for multi-equipment orchestration, according to an embodiment. As shown in FIG. 1C, a multi-equipment orchestration system 160 is connected with various equipment, each of possibly different type. For example, the multi-equipment orchestration system 160 is connected to one or more refrigeration equipment 165, one or more lighting systems 170, one of more HVAC (heating, ventilation, and air conditioning) equipment 175, cooking equipment 180, and so on. The multi-equipment orchestration system 160 may interact with each equipment to gather information or may store information describing various types of equipment and obtain information describing the equipment from another source. The multi-equipment orchestration system 160 may further interact with external systems to obtain various types of information, for example, cost models describing cost of power consumed by the equipment and variation of the cost over time. The multi-equipment orchestration system 160 orchestrates a particular equipment based on information describing multiple equipment. For example, the multi-equipment orchestration system 160 may control the temperature of a refrigeration equipment using techniques described herein so as to optimize power consumption over multiple equipment of a facility. Accordingly, if the multi-equipment orchestration system 160 receives information that power consumption of various types of equipment is high during a particular time period, the multi-equipment orchestration system 160 may adjust the temperature of refrigeration equipment 165 to optimize the overall power consumption. Similarly, of the multi-equipment orchestration system 160 receives cost model indicating that cost of power is high during a particular time interval T1 and lower during a time interval T2, the multi-equipment orchestration system 160 may orchestrate the refrigeration equipment 165 such that the power consumption is reduced during time interval T1 and increased during T2.

According to some embodiments, the multi-equipment orchestration system 160 uses data science techniques for building models for orchestration of equipment. For example, the multi-equipment orchestration system 160 may use artificial intelligence techniques such as machine learning based models to make predictions used to control temperature of various equipment based on cross-equipment optimization of parameters such as power consumption or cost of power. The system plots energy consumption patterns of each facility for individual equipment as well as overall energy consumption and provides that as information used for control of temperature of equipment. The multi-equipment orchestration system 160 uses optimization models to orchestrate demand response across multiple facilities, each facility using multiple equipment. The multi-equipment orchestration system 160 trains and uses predictive models that forecast demand in small time intervals, thereby allowing intelligent temperature control of various equipment based on predicted demand. The multi-equipment orchestration system 160 uses optimization models to perform load shifting and flattening overall demand curve of a facility. A facility may be associated with an organization or a business that may be a customer or tenant of the multi-equipment orchestration system 160.

FIG. 1D illustrates various techniques used for controlling the temperature of an equipment according to various embodiments. The system may observe the characteristics of the temperature of the equipment or an organization with multiple equipment. For example, the system may determine peak hours of the organization when the power consumption of the organization is highest. The system modifies the temperature of at least some of the equipment so as to optimize the power consumption of the organization, for example, by performing load shifting. For example, the temperature of the equipment may be reduced before reaching the peak hours so that the equipment does not consume power during the peak hours. The cost of power consumption during peak hours may be high. Therefore, load shifting as disclosed herein optimizes cost of power for the organization.

According to an embodiment, the multi-equipment orchestration system 160 trains and executes machine learning models for predicting demand response. A machine learning model receives variables including operating hours, special operating hours, controllable loads, and so on. The machine learning model predicts a list of facilities participating in a demand response of a particular length of time, for example, a list of facilities (or customers) participating in a 4 hour demand response or a list of facilities participating in a 2 hour demand response. The multi-equipment orchestration system 160 may maintain profiles of each facility to obtain the variable provided as input to the machine learning model.

According to an embodiment, the multi-equipment orchestration system 160 trains and executes a machine learning model for load shifting. The multi-equipment orchestration system 160 extracts features from sources including forecasted hourly carbon emission rate and utility or aggregator data on energy pricing. The system provides following features as input to the machine learning model: hourly average carbon emission rate, energy cost $/kWh, hourly maximum controllable load, hourly predicted load, peak demand hour indicator, and other variables. The machine learning model predicts hours and amount of controllable load to shift in a future time interval, for example, the prediction may be made 24 hours in advance.

According to an embodiment, the multi-equipment orchestration system 160 trains and executes a machine learning model for peak shaving. According to an embodiment, the machine learning model is trained using historical data for a facility. The system uses following data sources to extract features provided as input to the machine learning model: a facility's historical load data, and historical and forecasted weather data from a service that provides weather data API (e.g., visual crossing.) The machine learning model includes following variables as input: same time load from previous days, environmental attributes such as air temperature, wind direction, dew point, windspeed, sea level pressure, and other variables. The machine learning model predicts energy demand of the facility for a future time interval. The machine learning model may predict energy demand (or power consumption) of the facility at a particular periodicity, for example, in 15 minutes interval. The prediction is made in advance, for example, 24 hours ahead.

### System Architecture

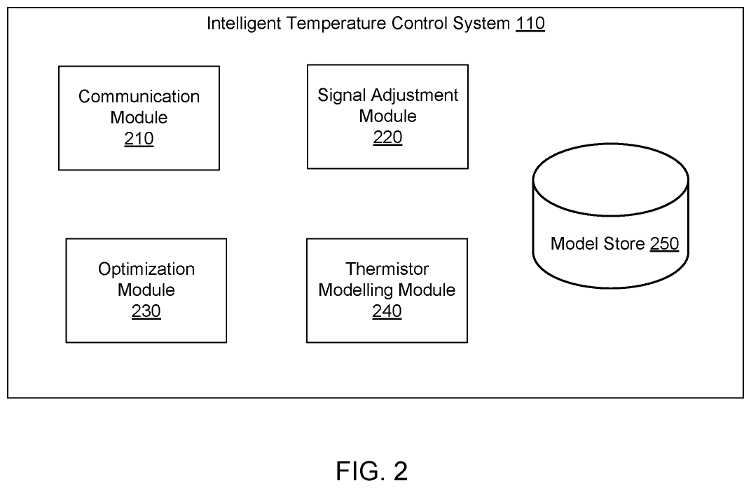

FIG. 2 shows the system architecture of an intelligent temperature control system, according to an embodiment. The intelligent temperature control system 110 includes a communication module 210, a signal adjustment module 220, an optimization module 230, a thermistor modeling module 240, and a model store 250. In other embodiments, the intelligent temperature control system 110 may include other modules not described herein. Functionality indicated as provided by a particular module may be implemented by other modules instead. The modules shown in the intelligent temperature control system 110 may be implemented by other systems. For example, the optimization module 230 may execute in a different computing system to train a machine learning model such that the trained machine learning model is transmitted to the intelligent temperature control system 110 and executed in the intelligent temperature control system 110.

The communication module 210 communicates with systems outside the intelligent temperature control system 110 which may include the control module 130 of the equipment 100, the thermistor 150, or the external system 120. The communication module 210 receives the signal generated by the thermistor 150. The communication module 210 communicates with the external system 120 to receive information that may be used for modifying the signal received from the thermistor 150. For example, the external system 120 may provide cost information describing how the cost of the power consumed by various equipment depends on various factors, for example, how the cost of the power varies over time. This allows the intelligent temperature control system 110 to modify the signal generated by the thermistor such that the modified signal optimizes the overall cost power consumed by the refrigeration equipment. According to an embodiment, the intelligent temperature control system 110 modifies the signal generated by the thermistor such that the modified signal optimizes the overall cost power consumed by a plurality of equipment of a facility, for example, a plurality of equipment including an air conditioning equipment, a heating equipment, lighting of the facility and so on in addition to the refrigeration equipment. In an embodiment, the communication module 210 uses LoRa (long range) radio signals to communicate with external systems. Other embodiments may use other communication channels for communicating with external systems, for example, WiFi.

The signal adjustment module 220 executes the processes described herein to adjust (i.e., modify) the signal received from the thermistor to generate a modified signal that is provided to the control module 130 of the equipment 100 being monitored and controlled using the thermistor 150. The signal received from the thermistor 150 may be a voltage signal. The signal adjustment module 220 generates a modified voltage signal and provides it to the control module 130.

The optimization module 230 performs optimization to determine the optimal signal to be provided to the control module 130 based on a given signal received from the thermistor 150 and other factors that are relevant. For example, the optimization module 230 may determine the optimal signal to be provided to the control module 130 for optimizing the power consumption of the equipment 100 (e.g., a refrigeration equipment) or the power consumption of a plurality of equipment of a facility including the equipment 100. Accordingly, the optimization module 230 determines the temperature to which the equipment 100 should be set using the control module 130 so as to optimize a set of criteria, for example, as minimizing the power consumption.

According to an embodiment, the optimization module 230 performs optimization by adjusting the control setpoint at a higher value which, for a refrigeration system, would reduce the immediate energy consumption or delay the consumption to a more optimum time. The optimization module 230 may adjust the control setpoint at a lower value which, for a refrigeration system, can take advantage of thermal inertia by pre-cooling, thus shifting power consumption at an earlier more optimum time. Setpoint adjustments may be based on various factors including: information from additional sensors, ensuring adequate content temperature control. Setpoint adjustments may be performed using: models updated with pertinent information such as the environment, the equipment content, or the power consumption of the equipment or neighboring devices; predictive models; or, artificial intelligence algorithms with a wide dataset reaching beyond the immediate system.

FIG. 1C depicts an optimization scenario around a time of higher energy cost (‘peak hours’) using the systems disclosed according to an embodiment. Pre-cooling is first applied, followed by a temporary relaxation of the controls to a higher but safe and less energy-consuming setpoint.

The thermistor modeling module 240 determines the behavior of a thermistor used by a particular equipment connected to the intelligent temperature control system 110. In an embodiment, the intelligent temperature control system 110 receives various values of temperature being monitored by the thermistor along with the signal generated by the thermistor. The intelligent temperature control system 110 maps various known temperature values of the refrigeration equipment to values of signal generated by the thermistor to plot a graph (i.e., a curve or a mapping) representing the behavior of the thermistor. Accordingly, the intelligent temperature control system 110 does not have to be provided with information describing the behavior of the different thermistors. The intelligent temperature control system 110 is able to learn the behavior of the thermistor by monitoring the behavior during normal operation of the refrigeration equipment. When the system is connected to (or installed at) a refrigeration equipment, the system executes an initial phase in which the system determines the mapping from signal generated by the thermistor to the temperature of the thermistor. The mapping represents the behavior of the thermistor. Subsequently, the system uses the mapping generated for controlling the temperature of the equipment using additional factors.

In some embodiments, an external system 120 generates models that are used by the intelligent temperature control system 110. These models may describe the behavior of thermistors, or they may predict a signal for providing to the control module based on the signal received from the thermistor and other variables considered. The model store 250 stores these models. According to various embodiments, the models are machine learning based models such as neural networks that are trained using training data such as historical data collected from equipment that is running. In an embodiment, the models are updated remotely, for example, uploaded to the intelligent temperature control system 110 on a periodic bases or as needed. This allows the system to implement various techniques for controlling the temperature of the refrigeration equipment. Furthermore, this allows the system to modify the strategy used for controlling the temperature of the refrigeration equipment. For example, a model may incorporate cost information of power consumed by the refrigeration equipment. The cost of the power may be higher at particular times of the day or during particular days of the week. The intelligent temperature control system 110 may determine the final temperature of the refrigeration equipment based on the cost information such that the temperature of the refrigeration equipment is kept relatively higher when the cost of power is higher and the temperature of the refrigeration equipment is kept relatively lower when the cost of power is lower, thereby optimizing the overall cost of the power. The intelligent temperature control system 110 may receive newer cost models and update them if the cost of power changes over time. In another embodiment, the intelligent temperature control system 110 receives information describing power consumption of other equipment within the facility. The information may be updated on a periodic basis or provided as a table that captures the information for a long time period. The intelligent temperature control system 110 adjusts the temperature of the refrigeration equipment to incorporate the information describing power consumption of other equipment within the facility. For example, if the power consumption of various equipment during a time period is determined to be high, the intelligent temperature control system 110 may increase the temperature of the refrigeration equipment to reduce the power consumption. Similarly, if the power consumption of various equipment during a time period is determined to be low, the intelligent temperature control system 110 decreases the temperature of the refrigeration equipment since it is ok to consume additional power during this time period. Accordingly, the intelligent temperature control system 110 keeps the temperature within a threshold of a target temperature such that the temperature is increased above the target temperature or decreased below the target temperature depending on external factors such as power consumption of other equipment or the power consumption of the refrigeration equipment.

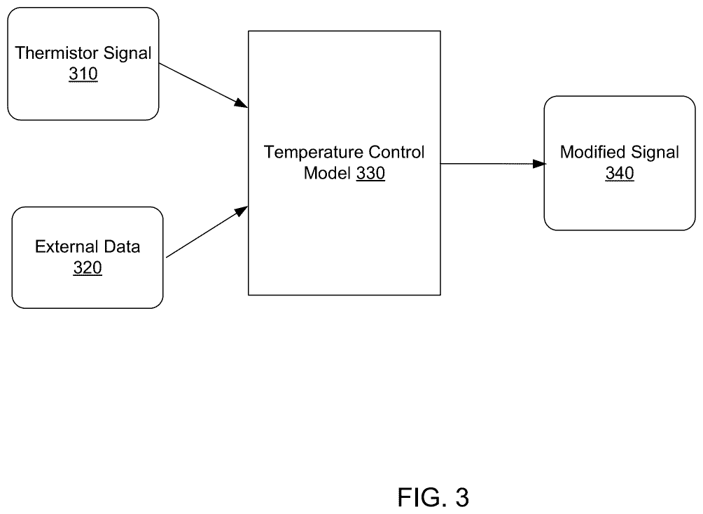

FIG. 3 illustrates a temperature control model used by the intelligent temperature control system, according to an embodiment. The temperature control model 330 receives as input the thermistor signal 310 that is based on the temperature of the equipment 100 and external data 320. The external data may be received from the external system 120. The temperature control model 330 according to an embodiment, predicts a modified signal 340 based on the thermistor signal 310 and the external data 320. The intelligent temperature control system 110 provides the modified signal 340 to the equipment 100 such that the temperature of the equipment 100 may be set to a value different from what the thermistor indicates and is based on information in addition to the thermistor signal 310.

### Hardware Architecture

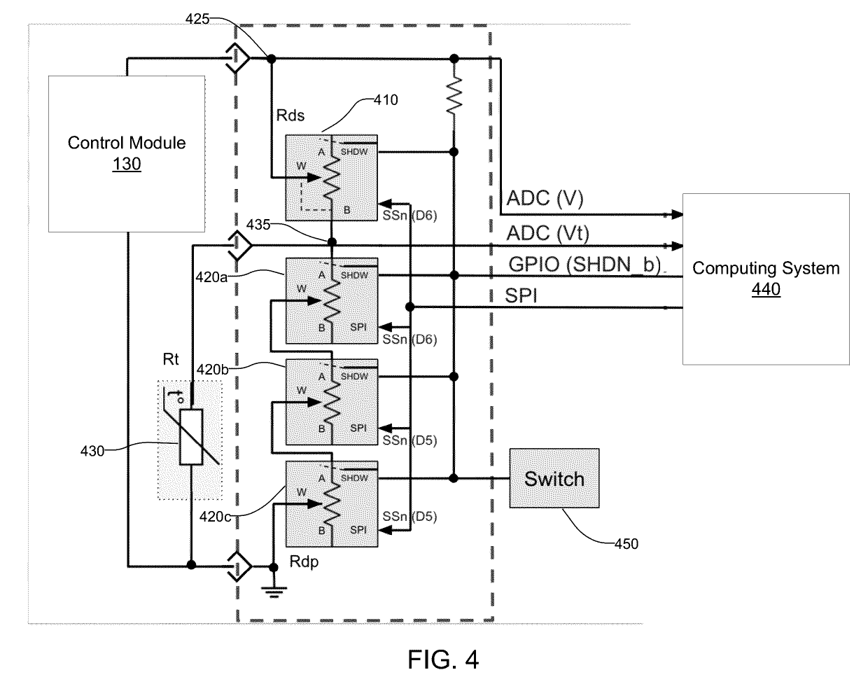

FIG. 4 shows a hardware architecture of a system used for intelligent temperature control of equipment, according to an embodiment. The thermistor 430 (also indicated as Rt) is associated with the equipment 100 and senses the temperature of the equipment. One or more variable resistors are connected to the thermistor 430. A potentiometer may be used as a variable resistor. As shown in FIG. 4, variable resistors 420a, 420b, 420c are connected in series with each other and the combination of the variable resistors 420a, 420b, 420c is connected in parallel with the thermistor 430. The variable resistor 410 is connected in series with the thermistor. The variable resistor 410 connects the thermistor with the input of the control module 130. The control module 130 acts as a feedback control module. The resistance values of the variable resistors 410 and 420 can be changed. For example, reducing the resistance value of the variable resistors 420 connected in parallel with the thermistor causes the voltage signal across the thermistor to decrease. Similarly, increasing the resistance value of the variable resistor 410 causes the voltage signal provided to the control module to drop. The computing system 440 receives the signals from various points of the circuit and processes them. For example, the signal ADC(Vt) represents the signal generated by the thermistor and is the voltage at the node 435. The signal ADC(V) represents the signal provided to the control module 130 that determines the temperature of the equipment 100 and represents the voltage at the node 425. The computing system 440 may disable the variable resistors 410 and 420 and receive the values of the signals ADC(V) and ADC(Vt) to determine the behavior of the thermistor. The computing system 440 may cause the resistance values of the variable resistors 410 and 420 to modify the signal provided to the control module 130. The switch 450 may be used to disable the variable resistors if necessary to that the equipment 100 is controlled directly by the signal generated by the thermistor.

### Process for Managing Temperature of Equipment

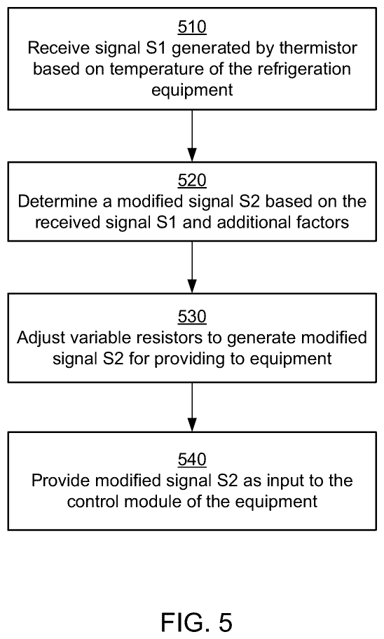

FIG. 5 is a flowchart illustrating the overall process of controlling temperature of refrigeration equipment according to an embodiment. The steps of processes described herein may be performed in an order different from that indicated herein, to the extent permitted by the data flow of the process. The steps are described as being performed by a system, for example, the intelligent temperature control system 110 and may be performed by various modules shown in FIG. 2. The techniques disclosed are described in connection with refrigeration equipment by may be applied to other types of equipment, for example, air conditioning equipment, heating equipment, or other types of machinery used in industry.

The system receives 510 a signal S1 from a thermistor mounted in a refrigeration equipment. The signal S1 is generated by the thermistor based on the temperature of the refrigeration equipment. The system determines 520 a modified signal S2 based on the received signal S1 and one or more other factors, for example, based on information received from an external system. The system adjusts 530 the variable resistors associated with the thermistor, for example, resistors 410 and 420 so that the voltage of the node 425 matches the modified signal S2. The system provides the modified signal S2 as input to the control module 130 of the refrigeration equipment which in turn sets the temperature of the refrigeration equipment based on the modified signal S2 rather than the signal S1 generated by the thermistor.

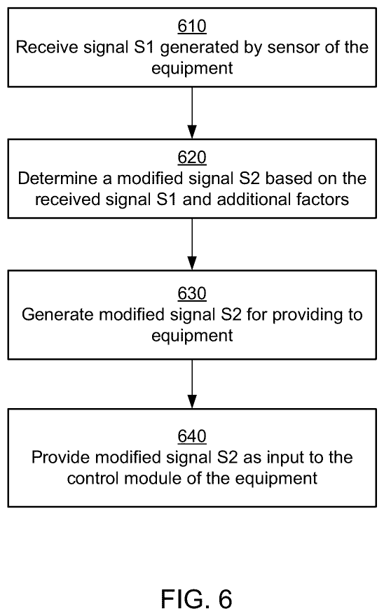

FIG. 6 is a flowchart illustrating the overall process of controlling an attribute of an equipment according to an embodiment. The steps of processes described herein may be performed in an order different from that indicated herein, to the extent permitted by the data flow of the process. The techniques disclosed may be applied to any kind of equipment, for example, air conditioning equipment, heating equipment, refrigeration equipment, or other types of machinery used in industry.

The system receives 610 a signal S1 from a sensor mounted in an equipment. The signal S1 is generated by the thermistor based on the temperature of the refrigeration equipment. The system determines 620 a modified signal S2 based on the received signal S1 and one or more other factors, for example, based on information received from an external system. The system generates 630 the modified signal S2, for example, using appropriate circuitry. The system provides 640 the modified signal S2 as input to a control module of the equipment which in turn sets the attribute of the equipment based on the modified signal S2 rather than the signal S1 generated by the sensor.

### Applications

The techniques disclosed herein allow temperature of various kinds of equipment to be controlled in an intelligent manner to allow various types of applications. According to an embodiment, the external data/information used to control the temperature of an equipment represents data describing other equipment, for example, a plurality of equipment of a facility. For example, the data may represent power consumption of other equipment used in the facility. If during a time period the system determines that the power consumption of other equipment in the facility is high (above a threshold value), the system may conserve power by reducing the temperature of the refrigeration equipment. Accordingly, the system optimizes the power consumption across multiple equipment used by a facility by controlling the temperature of a particular equipment (e.g., refrigeration equipment). The disclosed system provides the infrastructure for incorporating such external data while adjusting the temperature of the refrigeration equipment.

### Computing Machine Architecture

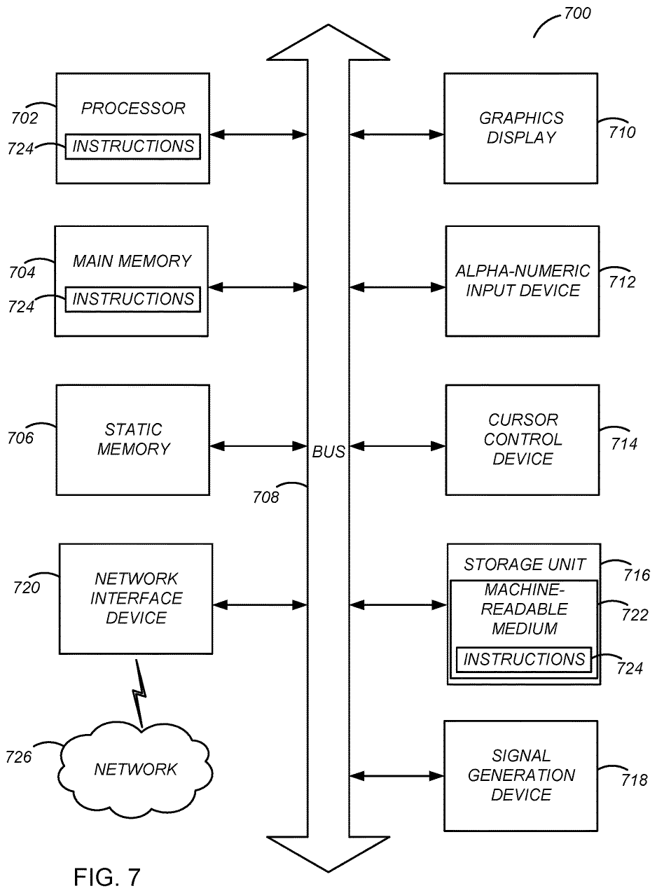

FIG. 7 is a block diagram illustrating components of an example machine able to read instructions from a machine-readable medium and execute them in a processor (or controller). Specifically, FIG. 7 shows a diagrammatic representation of a machine in the example form of a computer system 700 within which instructions 724 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes a processor 702 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a static memory 706, which are configured to communicate with each other via a bus 708. The computer system 700 may further include graphics display unit 710 (e.g., a plasma display panel (PDP), a liquid crystal display (LCD), a projector, or a cathode ray tube (CRT)). The computer system 700 may also include alphanumeric input device 712 (e.g., a keyboard), a cursor control device 714 (e.g., a mouse, a trackball, a joystick, a motion sensor, or other pointing instrument), a storage unit 716, a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network 726 via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies disclosed herein. The term “machine-readable medium” includes, but not be limited to, data repositories in the form of solid-state memories, optical media, and magnetic media.

### ALTERNATIVE EMBODIMENTS

It is to be understood that the figures and descriptions of the present invention have been simplified to illustrate elements that are relevant for a clear understanding of the present invention, while eliminating, for the purpose of clarity, many other elements found in a typical system. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for generating reports based on instrumented software through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for controlling temperature of a refrigeration equipment, comprising:
receiving signal generated by a thermistor mounted in the refrigeration equipment;
determining an optimal temperature for the refrigeration equipment, the optimal temperature determined based on a plurality of factors including the signal and at least one or more external factors;
modifying the signal received from the thermistor to generate a modified signal for achieving the optimal temperature; and
sending the modified signal to a control module of the refrigeration equipment, wherein the control module controls the refrigeration equipment to change a current temperature of the refrigeration equipment towards the optimal temperature.

2. The computer-implemented method of claim 1, wherein the control module controls the refrigeration equipment by performing steps comprising:
determining by the control module that the current temperature is lower than the optimal temperature; and
responsive to determining by the control module that the current temperature is lower than the optimal temperature, increasing the temperature of the refrigeration equipment.

3. The computer-implemented method of claim 1, wherein the control module controls the refrigeration equipment by performing steps comprising:
determining by the control module that the current temperature is higher than the optimal temperature; and
responsive to determining by the control module that the current temperature is lower than the optimal temperature, reducing the temperature of the refrigeration equipment.

4. The computer-implemented method of claim 1, wherein the optimal temperature is determined to minimize a power consumption of the refrigeration equipment.

5. The computer-implemented method of claim 1, wherein the optimal temperature is determined to minimize a power consumption of a plurality of equipment of a facility including the refrigeration equipment.

6. The computer-implemented method of claim 1, wherein the optimal temperature is determined by executing a machine learning model trained to output a score indicating energy demand of a facility including the refrigeration equipment.

7. The computer-implemented method of claim 6, wherein the machine learning model is configured to receive as input, feature comprising environmental attributes associated with the refrigeration equipment.

8. A non-transitory computer readable storage medium comprising instructions that when executed by one or more computer processors, cause the one or more computer processors to perform steps of a method for controlling an equipment, the steps comprising:
receiving signal generated by a sensor mounted in the equipment, the signal monitoring an attribute of the equipment;
determining an optimal target attribute value for the equipment, the optimal target attribute value based on a plurality of factors including the signal and at least one or more external factors;
modifying the signal received from the sensor to generate a modified signal for achieving the optimal target attribute value for the equipment; and
sending the modified signal to a control module of the equipment, wherein the control module controls the equipment to achieve the optimal target attribute value.

9. The non-transitory computer readable storage medium of claim 8, wherein the control module controls the equipment by performing steps comprising:
determining by the control module that a current attribute value is lower than the optimal target attribute value; and
responsive to determining by the control module that the current attribute value is lower than the optimal target attribute value, modifying the signal to increase the current attribute value.

10. The non-transitory computer readable storage medium of claim 8, wherein the control module controls the equipment by performing steps comprising:
determining by the control module that a current attribute value is higher than the optimal target attribute value; and
responsive to determining by the control module that the current attribute value is higher than the optimal target attribute value, modifying the signal to decrease the current attribute value of the equipment.

11. The non-transitory computer readable storage medium of claim 8, wherein the attribute represents a temperature of the equipment and the optimal target attribute value is determined to minimize a power consumption of a plurality of equipment of a facility including the equipment.

12. The non-transitory computer readable storage medium of claim 8, wherein modifying the signal is performed by changing a value of a resistor associated with the signal.

13. The non-transitory computer readable storage medium of claim 8, the instructions further causing the one or more computer processors to perform steps comprising:
calibrating the sensor based on the signal generated by a sensor to determine the optimal target attribute value of the signal for the sensor.

14. The non-transitory computer readable storage medium of claim 8, wherein the equipment is one of a refrigeration equipment, a heating equipment, or an air-conditioning equipment.

15. A computer system comprising:
one or more computer processors; and
a non-transitory computer readable storage medium comprising instructions that when executed by one or more computer processors, cause the one or more computer processors to perform steps of a method for controlling a refrigeration equipment, the steps comprising:
receiving signal generated by a thermistor mounted in the refrigeration equipment;
determining an optimal temperature for the refrigeration equipment, the optimal temperature determined based on a plurality of factors including the signal and at least one or more external factors;
modifying the signal received from the thermistor to generate a modified signal for achieving the optimal temperature; and
sending the modified signal to a control module of the refrigeration equipment, wherein the control module controls the refrigeration equipment to change a current temperature of the refrigeration equipment towards the optimal temperature.

16. The computer system of claim 15, wherein the control module controls the refrigeration equipment by performing steps comprising:
determining by the control module that the current temperature is lower than the optimal temperature; and
responsive to determining by the control module that the current temperature is lower than the optimal temperature, increasing the current temperature of the refrigeration equipment.

17. The computer system of claim 15, wherein the control module controls the refrigeration equipment by performing steps comprising:
determining by the control module that the current temperature is higher than the optimal temperature; and
responsive to determining by the control module that the current temperature is higher than the optimal temperature, reducing the current temperature of the refrigeration equipment.

18. The computer system of claim 15, wherein the optimal temperature is determined to minimize a power consumption of the refrigeration equipment.

19. The computer system of claim 15, wherein the optimal temperature is determined to minimize a power consumption of a plurality of equipment of a facility including the refrigeration equipment.

20. The computer system of claim 15, wherein the optimal temperature is determined by executing a machine learning model trained to output a score indicating energy demand of a facility including the refrigeration equipment, wherein the machine learning model is configured to receive as input, features comprising environmental attributes associated with the refrigeration equipment.
